(19) United States
(12) Patent Application Publication
(10) Pub. No.: US 2007/0094450 A1
(43) Pub. Date: Apr. 26, 2007

(54) Multi-level cache architecture having a selective victim cache

(75) Inventor: Steven Paul VanderWiel, Rosemount, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/259,313

(22) Filed: Oct. 26, 2005

(51) Int. Cl. G06F 12/00

(52) U.S. Cl. 711/133; 711/122

(57) ABSTRACT

A computer system cache memory contains at least two levels. A lower level selective victim cache receives cache lines evicted from a higher level cache. A selection mechanism selects lines evicted from the higher level cache for storage in the victim cache, only some of the evicted lines being selected for the victim. Preferably, two priority bits associated with each cache line are used to select lines for the victim. The priority bits indicate whether the line has been re-referenced while in the higher level cache, and whether it has been reloaded after eviction from the higher level cache.

### FIELD OF THE INVENTION

The present invention relates to digital data processing hardware, and in particular to the design and operation of cached memory and supporting hardware for processing units of a digital data processing device.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises a central processing unit (CPU) and supporting hardware necessary to store, retrieve and transfer information, such as communications buses and memory. It also includes hardware necessary to communicate with the outside world, such as input/output controllers or storage controllers, and devices attached thereto such as keyboards, monitors, tape drives, disk drives, communication lines coupled to a network, etc. The CPU is the heart of the system. It executes the instructions which comprise a computer program and directs the operation of the other system components.

From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall speed of a computer system (also called the “throughput”) may be crudely measured as the number of operations performed per unit of time. Conceptually, the simplest of all possible improvements to system speed is to increase the clock speeds of the various components, and particularly the clock speed of the processor. E.g., if everything runs twice as fast but otherwise works in exactly the same manner, the system will perform a given task in half the time. Early computer processors, which were constructed from many discrete components, were susceptible to significant clock speed improvements by shrinking and combining components, eventually packaging the entire processor as an integrated circuit on a single chip, and increased clock speed through further size reduction and other improvements continues to be a goal. In addition to increasing clock speeds, it is possible to increase the throughput of an individual CPU by increasing the average number of operations executed per clock cycle.

A typical computer system can store a vast amount of data, and the processor may be called upon to use any part of this data. The devices typically used for storing mass data (e.g., rotating magnetic hard disk drive storage units) require relatively long latency time to access data stored thereon. If a processor were to access data directly from such a mass storage device every time it performed an operation, it would spend nearly all of its time waiting for the storage device to return the data, and its throughput would be very low indeed. As a result, computer systems store data in a hierarchy of memory or storage devices, each succeeding level having faster access, but storing less data. At the lowest level is the mass storage unit or units, which store all the data on relatively slow devices. Moving up the hierarchy is a main memory, which is generally semiconductor memory. Main memory has a much smaller data capacity than the storage units, but a much faster access. Higher still are caches, which may be at a single level, or multiple levels (level 1 being the highest), of the hierarchy. Caches are also semiconductor memory, but are faster than main memory, and again have a smaller data capacity. One may even consider externally stored data, such as data accessible by a network connection, to be even a further level of the hierarchy below the computer system's own mass storage units, since the volume of data potentially available from network connections (e.g., the Internet) is even larger still, but access time is slower.

When the processor generates a memory reference address, it looks for the required data first in cache (which may require searches at multiple cache levels). If the data is not there (referred to as a “cache miss”), the processor obtains the data from memory, or if necessary, from storage. Memory access requires a relatively large number of processor cycles, during which the processor is generally idle. Ideally, the cache level closest to the processor stores the data which is currently needed by the processor, so that when the processor generates a memory reference, it does not have to wait for a relatively long latency data access to complete. However, since the capacity of any of the cache levels is only a small fraction of the capacity of main memory, which is itself only a small fraction of the capacity of the mass storage unit(s), it is not possible to simply load all the data into the cache. Some technique must exist for selecting data to be stored in cache, so that when the processor needs a particular data item, it will probably be there.

A cache is typically divided into units of data called lines, a line being the smallest unit of data that can be independently loaded into the cache or removed from the cache. In order to support any of various selective caching techniques, caches are typically addressed using associative sets of cache lines. An associative set is a set of cache lines, all of which share a common cache index number. The cache index number is typically derived from selective bits of a referenced address. The cache being much smaller than main memory, an associative set holds only a small portion of the main memory addresses which correspond to the cache index number.

Because the cache has a fixed size, when data is brought into a cache, it is necessary to select some other data already in the cache for removal, or “eviction” from the cache, to make room for the new data. Often, the data selected for removal will be referenced again soon afterwards. In particular, where the cache is designed using associativity sets, another cache line in the same associativity set must be selected for removal. If a particular associativity set contains frequently referenced cache lines (referred to as a “hot” associativity set), it is likely that the evicted cache line will be needed again soon.

One approach to cache design is the use of a “victim cache”. A victim cache is typically an intermediate level cache which receives all the evicted cache lines from the cache immediately above it in the cache hierarchy. The victim cache design recognizes that some of the evicted cache lines are likely to be needed again soon. Frequently used cache lines will typically be referenced again and brought into the higher level cache before they are evicted from the victim cache, while unneeded lines will eventually be evicted from the victim cache to a lower level (or to memory) according to some selection algorithm.

Conventional victim cache designs use the victim cache to receive all data evicted from the higher level cache. However, in many system environments most of this evicted data is not likely to be needed again, while a relatively small portion may represent frequently accessed data. If the victim cache is sufficiently large to hold most or all of the evicted lines which are likely to be re-referenced, it must also be large enough to hold a substantial number of unneeded lines. If the victim cache is made smaller, some of the needed lines will be evicted before they can be re-referenced and returned to the higher level cache. Therefore, conventional victim caches are often an inefficient technique for selective data to be stored in cache, and it can be questioned whether the hardware allocated to the victim cache is not better applied to increasing the size of other caches.

Although conventional techniques for designing cache hierarchies and selecting the cache contents have achieved limited success, it has been observed that in many environments, the processor spends the bulk of its time idling on cache misses. Increasing cache sizes can help, but there exists a need for improved techniques for the design and operation of caches which reduce the average access time without large increases in cache size.

### SUMMARY OF THE INVENTION

A computer system includes a main memory, at least one processor, and a cache memory having at least two levels. A lower level selective victim cache receives cache lines evicted from a higher level cache. A selection mechanism selects lines evicted from the higher level cache for storage in the selective victim cache at a lower level, only some of the evicted lines being selected for storage in the victim cache.

In the preferred embodiment, two priority bits are associated with each cache line. These bits are reset when the cache line is first brought into the higher level cache from memory. A first bit is set if the cache line is re-referenced while in the higher level cache. The second bit is set if it is re-referenced after being evicted from the higher level cache, and before being evicted to memory. The second bit represents a high priority, the first bit a middle priority, and if neither bit is set, a low priority. When a line is evicted from the higher-level cache, it enters a relatively small queue for the selective victim cache. A higher priority cache line causes a lower priority line to be dropped from the queue, while a cache line which is no higher than any cache line in the queue causes the queue to advance, placing one element in the selective victim cache. Preferably, cache lines are evicted from the selective victim cache using a least-recently-used (LRU) technique.

In the preferred embodiment, both the higher level cache and the selective victim cache are accessed using selective bits of an address to obtain the index of an associativity set, and examining multiple cache lines within the indexed associativity set. Preferably, the number of associativity sets in the higher level cache is greater than the number in the selective victim cache. In an optional embodiment, the associativity sets of the selective victim cache are accessed using a hash function of address bits which distributes the contents of each associativity set in the higher level cache among multiple associativity sets in the victim cache to share the burden of any “hot” sets in the higher level cache.

Although the terms “higher level cache” and “lower level cache” are used herein, these are intended only to designate a relative cache level relationship, and are not intended to imply that the system contains only two levels of cache. As used herein, “higher level” refers to a level that is relatively closer to the processor core. In the preferred embodiment, there is at least one level of cache above the “higher level cache”, and at least one level of cache below the “lower level” or selective victim cache, which operate on any of various conventional principles.

By selectively excluding certain cache lines from the victim cache in accordance with the preferred embodiment, a more effective use of available cache space can be obtained. In all cases, cache lines having a high priority (i.e., which have previously been re-referenced after eviction) will get into the victim cache. However, low priority lines will not necessarily enter the victim cache, and the degree to which low priority lines are allowed into the victim cache varies with the proportion of low to higher priority cache lines.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for utilizing a selective victim cache, according to the preferred embodiment of the present invention.

FIG. 2 represents in greater detail the hierarchy of various caches and associated structures for storing and addressing data, according to the preferred embodiment.

FIG. 3 is a diagram representing of the general structure of a cache including associated accessing mechanisms, according to the preferred embodiment.

FIG. 4 is a diagram representing in greater detail the victim cache queue and associated control logic, according to the preferred embodiment.

FIG. 5 is an illustrative example of the operation of the victim cache queue, according to the preferred embodiment.

### DETAILED DESCRIPTION OF THE PREFERRED EMBODIMENTS

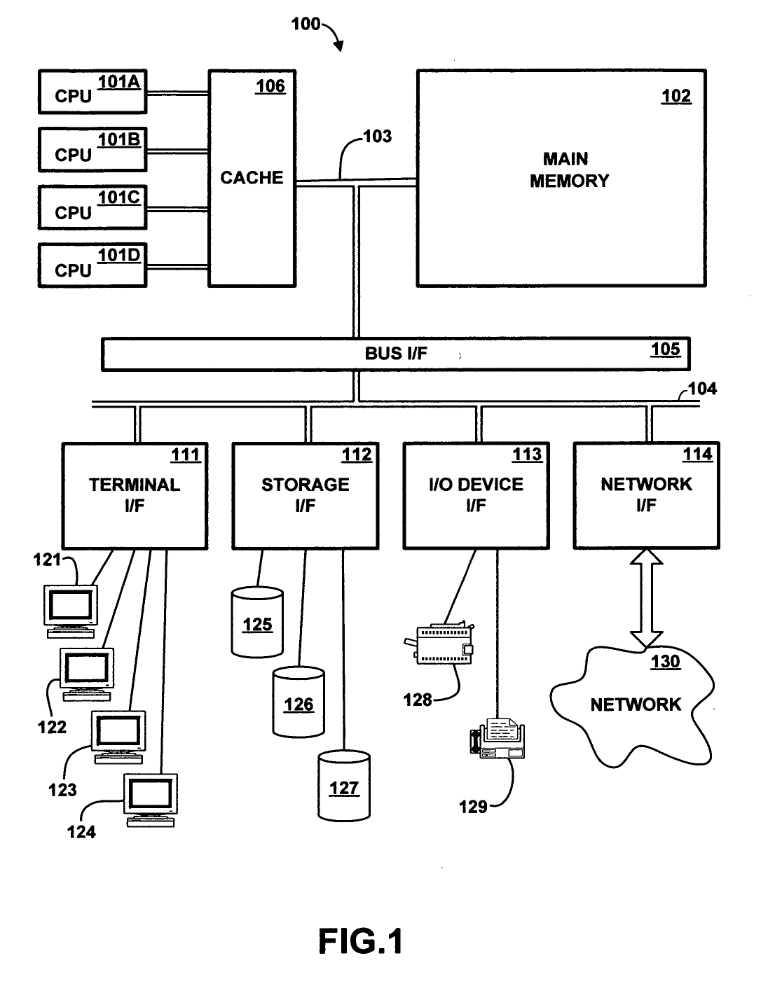

Referring to the Drawing, wherein like numbers denote like parts throughout the several views, FIG. 1 is a high-level representation of the major hardware components of a computer system 100 for utilizing a selective victim cache, according to the preferred embodiment of the present invention. The major components of computer system 100 include one or more central processing units (CPU) 101A-101D, main memory 102, cache memory 106, terminal interface 111, storage interface 112, I/O device interface 113, and communications/network interfaces 114, all of which are coupled for inter-component communication via buses 103, 104 and bus interface 105.

System 100 contains one or more general-purpose programmable central processing units (CPUs) 101A-101D, herein generically referred to as feature 101. In the preferred embodiment, system 100 contains multiple processors typical of a relatively large system; however, system 100 could alternatively be a single CPU system. Each processor 101 executes instruction stored in memory 102. Instructions and other data are loaded into cache memory 106 from main memory 102 for processing. Main memory 102 is a random-access semiconductor memory for storing data, including programs. Although main memory 102 and cache 106 are represented conceptually in FIG. 1 as single entities, it will be understood that in fact these are more complex, and in particular, that cache exists at multiple different levels, as described in greater detail herein.

Buses 103-105 provide communication paths among the various system components. Memory bus 103 provides a data communication path for transferring data among CPUs 101 and caches 106, main memory 102 and I/O bus interface unit 105. I/O bus interface 105 is further coupled to system I/O bus 104 for transferring data to and from various I/O units. I/O bus interface 105 communicates with multiple I/O interface units 111-114, which are also known as I/O processors (IOPs) or I/O adapters (IOAs), through system I/O bus 104. System I/O bus may be, e.g., an industry standard PCI bus, or any other appropriate bus technology.

I/O interface units 111-114 support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O and other device interface 113 provides an interface to any of various other input/output devices or devices of other types. Two such devices, printer 128 and fax machine 129, are shown in the exemplary embodiment of FIG. 1, it being understood that many other such devices may exist, which may be of differing types. Network interface 114 provides one or more communications paths from system 100 to other digital devices and computer systems; such paths may include, e.g., one or more networks 130 such as the Internet, local area networks, or other networks, or may include remote device communication lines, wireless connections, and so forth.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary. It will further be understood that not all components shown in FIG. 1 may be present in a particular computer system. Several particular examples of such additional complexity or additional variations are disclosed herein, it being understood that these are by way of example only and are not necessarily the only such variations.

Although main memory 102 is shown in FIG. 1 as a single monolithic entity, memory may further be distributed and associated with different CPUs or sets of CPUs, as is known in any of various so-called non-uniform memory access (NUMA) computer architectures. Although memory bus 103 is shown in FIG. 1 as a relatively simple, single bus structure providing a direct communication path among cache 106, main memory 102 and I/O bus interface 105, in fact memory bus 103 may comprise multiple different buses or communication paths, which may be arranged in any of various forms, such as point-to-point links in hierarchical, star or web configurations, multiple hierarchical buses, parallel and redundant paths, etc. Furthermore, while I/O bus interface 105 and I/O bus 104 are shown as single respective units, system 100 may in fact contain multiple I/O bus interface units 105 and/or multiple I/O buses 104. While multiple I/O interface units are shown which separate a system I/O bus 104 from various communications paths running to the various I/O devices, it would alternatively be possible to connect some or all of the I/O devices directly to one or more system I/O buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. Computer system 100 may alternatively be a single-user system, typically containing only a single user display and keyboard input, or might be a server or similar device which has little or no direct user interface, but receives requests from other computer systems (clients).

While various system components have been described and shown at a high level, it should be understood that a typical computer system contains many other components not shown, which are not essential to an understanding of the present invention.

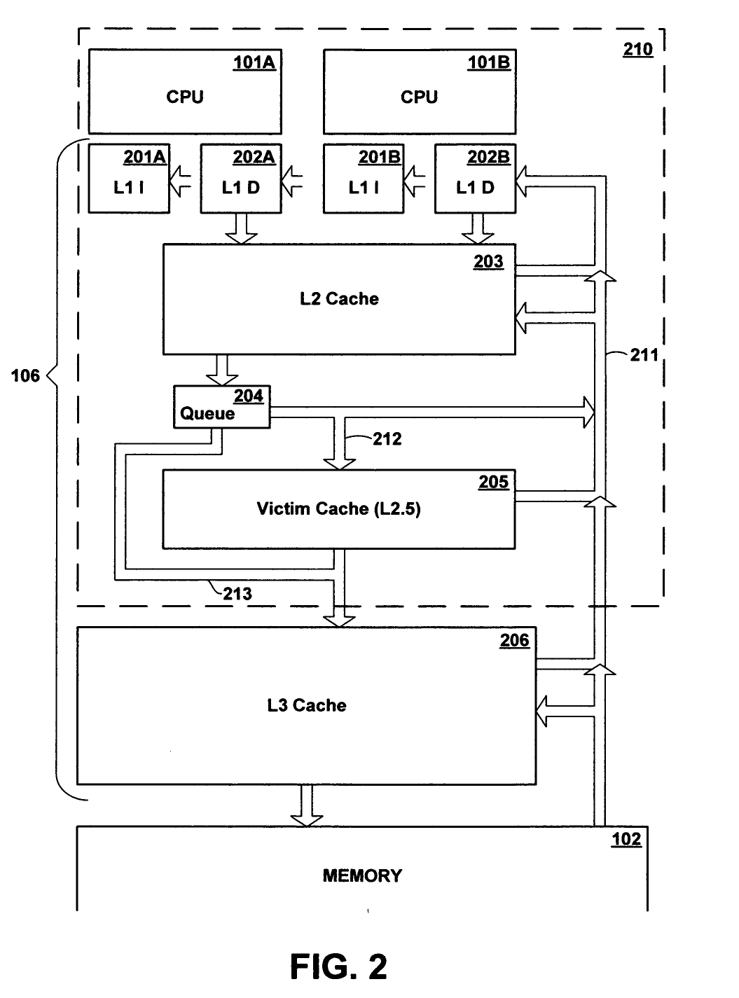

FIG. 2 represents in greater detail the hierarchy of various caches and associated data paths for accessing data from memory, according to the preferred embodiment. In this embodiment there is a hierarchy of caches in addition to main memory 102. Caches exist at levels designated level 1 (the highest level), level 2, level 3, and a victim cache (sometimes designated level 2.5) at a level between level 2 and level 3. Each processor 101 is associated with a respective pair of level 1 caches, which is not shared with any other processor. One cache of this pair is a level 1 instruction cache (L1 I-cache) 201A, 201B (herein generically referred to as feature 201), which the other cache of the pair is a level 1 data cache (L1 D-cache) 202A, 202B (herein generically referred to as feature 202). Each processor is further associated with a respective level 2 cache 203, a selective victim cache 205, and a level 3 cache 206; unlike the L1 caches, in the preferred embodiment each L2 cache and each L3 cache is shared among multiple processors, although one or more of such caches could alternatively be dedicated to single respective processors. For illustrative purposes, FIG. 2 shows two processors 101A, 101B sharing L2 cache 204, victim cache 205 and L3 cache 206, but the number of processors and caches at various levels of system 100 could vary, and the number of processors sharing a cache at each of the various levels could also vary. The number of processors sharing each L2, victim or L3 cache may or may not be the same. Preferably, there is a one-to-one correspondence between L2 caches and victim caches, although this is not necessarily required. There may be a one-to-one correspondence between L2 and L3 caches, or multiple L2 caches could be associated with the same L3 cache.

Caches generally become faster, and store progressively less data, at the higher levels (closer to the processor). In the exemplary embodiment described herein, typical of a large computer system, L2 cache 203 has a cache line size of 128 bytes and a total storage capacity of 2 Mbytes. L3 cache has a cache line size of 128 bytes and a total storage capacity 32 Mbytes. Both the L2 cache and the L3 cache are 8-way associative (i.e., each associativity set containing 8 cache lines of data, or 1 Kbyte), the L2 cache being divided into 2048 (2K) associativity sets, and the L3 cache being divided into 32K associativity sets. The L1 caches are smaller. The victim cache preferably has a size of 64K bytes, and is 4-way associative (each associativity set containing 4 cache lines, or 512 bytes, of data). The victim cache is therefore divided into 128 associativity sets. It will be understood, however, that these parameters are merely representative of typical caches in large systems using current technology. These typical parameters could change as technology evolves. Smaller computer systems will generally have correspondingly smaller caches, and may have fewer cache levels. The present invention is not limited to any particular cache size, cache line size, number of cache levels, whether caches at a particular level are shared by multiple processors or dedicated to a single processor, or similar design parameters.

As shown in FIG. 2, a load path 211 exists for loading data from main memory 102 into various caches, or for loading data from a lower level cache to a higher level cache. FIG. 2 represents this load path conceptually as a single entity, although it may in fact be implemented as multiple buses or similar data paths. As is well known, when a processor 101 requires access to a memory address, the caches are searched for the required data. If the data is not in the L1 cache, it is loaded from the highest available cache in which it can be found, or if not in cache, from main memory. (If the data is not in main memory, it is normally loaded from storage, but a load from storage takes so long that the executing process is normally swapped out of the processor.) In some architectures, certain data can also be speculatively loaded into cache, such as the L3 cache, before actually being accessed by the processor. In the preferred embodiment, data loaded into a higher level cache is also loaded into the cache levels below it other than victim cache 205, so that the lower level caches (other than the victim cache) contain copies of data in the higher level caches. When data is evicted from a higher level cache, it is not necessary to copy the data back to a lower level cache unless the data has been changed (except in the case of eviction from the L2 to the victim cache, as explained below).

Cache 205 acts as a victim cache, meaning that it receives data which is evicted from L2 cache 203. Cache 205 therefore does not contain copies of data in any of the higher level caches. When data is brought into the L2 and/or L1 caches, it by-passes victim cache 205. When data is evicted from the L2 cache, it is temporarily placed on victim cache queue 204 (regardless of whether or not it has been modified in the L2), and from there may eventually be written to victim cache 205, as represented by path 212. The path from L2 cache 203, through victim cache queue 204, is the only path by which data enters victim cache 205. Victim cache queue 204 acts as a selection means for selectively writing data to victim cache 205, as further explained herein. I.e., not all data evicted from L2 cache 203 is placed in victim cache 205; rather, data evicted from L2 cache is subjected to a selection process, whereby some of the evicted data is rejected for inclusion in the victim cache. If this rejected data has been altered while in a higher-level cache, it is written back to the L3 cache 206 directly, as represented by by-pass path 213; if the rejected data has not been altered, it can merely be deleted from queue 204, since a copy of the data already exists in L3 cache.

FIG. 2 is intended to depict certain functional relationships among the various caches, and the fact that certain components are shown separately is not intended as a representation of how the components are packaged. Modem integrated circuit technology has advanced to the point where at least some cache is typically packaged on the same integrated circuit chip as a processor (sometimes also referred to as a processor core), and it is even possible to place multiple processor cores on a single chip. In the preferred embodiment, CPUs 101A and 101B, together with L1 caches 201A, 201B, 202A, 202B, L2 cache 203, victim cache queue 204, and victim cache 205 are packaged on a single integrated circuit chip, indicated as feature 210 in dashed lines, while L3 cache 206 is packaged on a separate integrated circuit chip or chips mounted on a common printed circuit card with the corresponding processor chip. However, this arrangement is only one possible packaging arrangement, and as integrated circuit and other electronics packaging technology evolves it is conceivable that further integration will be employed.

As is known in the art, a cache is accessed by decoding an identification of an associativity set from selective address bits (or in some cases, additional bits, such as a thread identifier bit), and comparing the addresses of the cache lines in the associativity set with the desired data address. For example, where there are 2K associativity sets in a cache, 11 bits are needed to specify a particular associativity set from among the 2K. Ideally, these 11 bits are determined so that each associativity set has an equal probability of being accessed. In the preferred embodiment, L2 cache 203, victim cache 205 and L3 cache 206 are addressed using real addresses, and therefore a virtual address or effective address generated by the processor is first translated to a real address by address translation hardware (not shown) in order to access data in a cache. Address translation hardware may include any of various translation mechanisms as are known in the art, such as a translation look-aside buffer or similar mechanisms and associated access and translation hardware. Alternatively, as is known in some computer system designs, it would be possible to access some or all cache levels using virtual or effective addresses, without translation.

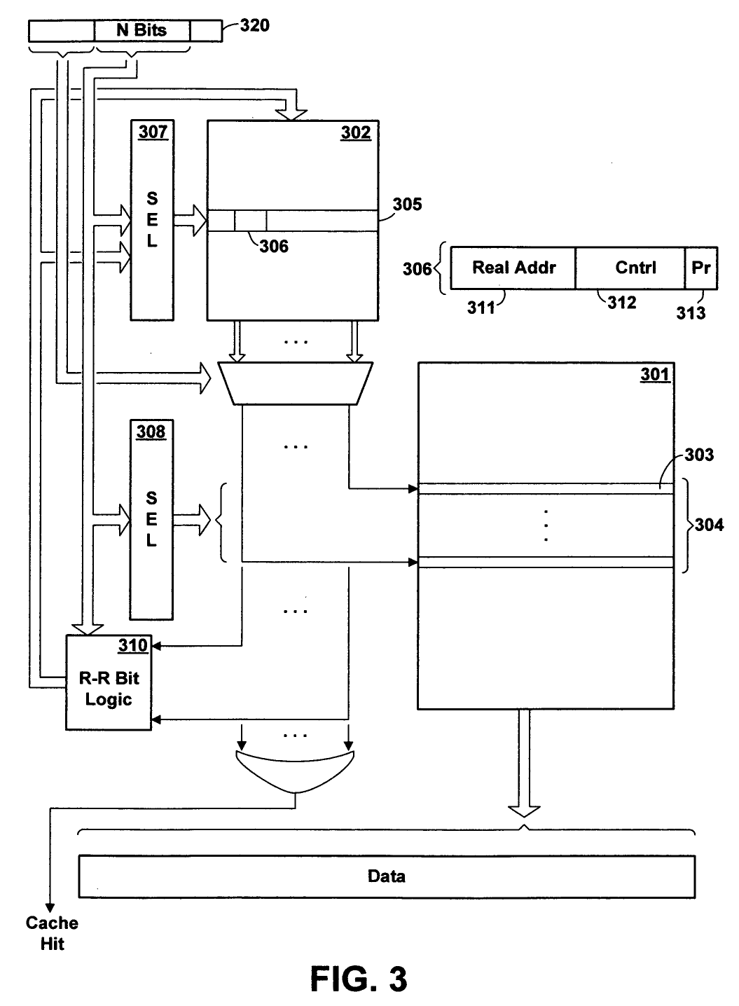

FIG. 3 is a representation of the general structure of a cache including associated accessing mechanisms, according to the preferred embodiment. FIG. 3 could represent any of either L2 cache 203, victim cache 205, or L3 cache 206. The L1 caches are typically similar. Referring to FIG. 3, a cache comprises a cache data table 301 and a cache index 302. The data table 301 contains multiple cache lines of data 303 grouped in associativity sets 304. In the preferred embodiment, each cache line 303 contains 128 bytes, and each associativity set 304 contains eight cache lines (in L2 cache 203 or L3 cache 206) or four lines (in victim cache 205). Index 302 contains multiple rows 305 of index entries 306, each row 305 corresponding to an associativity set 304 and containing either eight (L2 or L3 cache) or four (victim cache) index entries, as the case may be. Each index entry 306 contains at least a portion of a real address 311 of a corresponding cache line 303, certain control bits 312, and a pair of priority bits 313. Control bits 312 may include, but are not necessarily limited to: a dirty bit; one ore more bits for selecting a cache line to be evicted where necessary, such as least-recently-used (LRU) bits; one or more bits used as semaphores; locks or similar mechanisms for maintaining cache coherency; etc., as are known in the art. In the preferred embodiment, a cache line is selected for eviction from a cache according to any of various conventional least-recently-used techniques, although any eviction selection method, now known or hereafter developed, could alternatively be used.

A cache line is referenced by selecting a row 305 of index 304 corresponding to some function of a portion of the real address 320 of the desired data, using selector logic 307. In the preferred embodiment, this function is a direct decode of the N bits of real address at bit positions immediately above the 7 lowest bits (these 7 lowest bits corresponding to a cache line size of 128, or 2⁷), where N depends on the number of associativity sets in the cache, and is sufficiently large to select any associativity set. Generally, this means that N is the base 2 log of the number of associativity sets. I.e., for L2 cache 203, having 2048 associativity sets, N is 11; for L3 cache 206, having 32K associativity sets, N is 15; and for victim cache 205, having 128 associativity sets, N is 7. However, more complex hashing functions could alternatively be used, and in particular, a direct decode may be used for the L2 while a more complex hashing function is used for the victim cache. The real address contains more than (N+7) bits, so that multiple real addresses map to the same associativity set.

Thus, for L2 cache 203, real address bits 7 to 17 (where bit 0 is the lowest order bit) are input to selector logic 307; for L3 cache 206, real address bits 7 to 21 are input to selector logic; and for victim cache 205, real address bits 7 to 13 are input to selector logic. The real address 311 in each respective index entry 306 of the selected row 305 is then compared with the real address 320 of the referenced data by comparator logic 309. In fact, it is only necessary to compare the high-order bit portion of the real address (i.e., bits above the lowest order (N+7) bits), since the lowest 7 bits are not necessary to determine a cache line, and the next N bits inherently compare by virtue of the row selection. If there is a match, comparator logic 309 outputs a selection signal corresponding to the matching one of the eight or four index entries. Selector logic 308 selects an associativity set 304 of cache lines 303 using the same real address bits used by selector 307, and the output of comparator 309 selects a single one of the eight or four cache lines 303 within the selected associativity set.

Although selectors 307 and 308 are shown in FIG. 3 as separate entities, it will be observed that they perform identical function. Depending on the chip design, these may in fact be a single selector, having outputs which simultaneously select both the index row 305 in the index 302 and the associativity set 304 in the cache data table 301.

In operation, a memory reference is satisfied from L1 cache if possible. In the event of an L1 cache miss, the L2 and victim cache indexes (and possibly the L3) are simultaneously accessed using selective real address bits to determine whether the required data is in either cache. If the data is in L2, it is generally loaded into the L1 cache from L2, but remains unaltered in the L2. (Because the L2 cache may be shared, there could be circumstances in which the data is in an L1 cache of another processor and temporarily unavailable.).

If the data is in victim cache 205 (i.e, it is not in the L2), it is concurrently loaded into the L2 and the L1 from the victim, and the cache line is invalidated in the victim cache. In this case, a cache line from the L2 is selected for eviction using any of various conventional selection techniques, such as least recently used. If valid, the evicted line is placed in the victim cache queue 204. In order to make room in the victim cache queue, the queue may advance a line (not necessarily in the same associativity set as the invalidated line) into the victim cache, or may delete a line, as explained further herein. If a line is advanced into the victim cache, another cache line in the victim must be selected for eviction to the L3, again using a least recently used or any other appropriate technique. In order to make room in the L1 cache, one of the existing lines will be selected for eviction; however, since the L1 cache entries are duplicated in the L2, this evicted line is necessarily already in the L2, so it is not necessary to make room for it.

If the data is in neither the L2 nor the victim, then it is fetched from either L3 or main memory into the L2 and L1. In this case, a cache line from L2 is selected for eviction using any conventional technique. If valid, the evicted line is placed in the victim cache queue. The victim cache queue may advance an existing line into the victim cache, or may delete an existing line; if a line is advanced into the victim cache, another cache line in the victim must be selected for eviction to the L3, again using any conventional technique.

Priority bits 313 are used to establish priority for entry to victim cache 205. In the preferred embodiment, each priority bit pair comprises a reload bit and a re-reference bit. Both of these bits are initially set to zero when the cache line is loaded into any level cache from memory 102. If the cache line is re-referenced while in L2 cache 203 (i.e., referenced more than once), then the re-reference bit is set to one, and remains set at one for the duration of the time that the cache line is in cache (i.e., until it is evicted from all caches, and resides only in memory). Re-reference bit logic 310 detects a reference to an existing cache line as the output of a positive signal on any of the lines from comparator 309, and causes the re-reference bit in the corresponding index entry 306 to be set. Re-reference bit logic 310 is present only in the L1 caches 201, 202 and L2 cache 203; re-reference bit logic 310 is not required in the victim cache or L3 cache. The reload bit is used to indicate whether the cache line has been evicted from the L2 cache, and subsequently reloaded into L2 cache as a result of another reference to the cache line. Since the reload bit is used only by the victim cache queue 204, in the preferred embodiment it is set upon loading to the L2 from any of the lower level caches, i.e., it may be implemented by simply tying appropriate output signal line from the victim cache and L3 caches high. The output signal line from the victim cache queue to the L2 is also tied high for the same reason. The use of these priority bits to select cache lines for entry to the victim cache is further described herein.

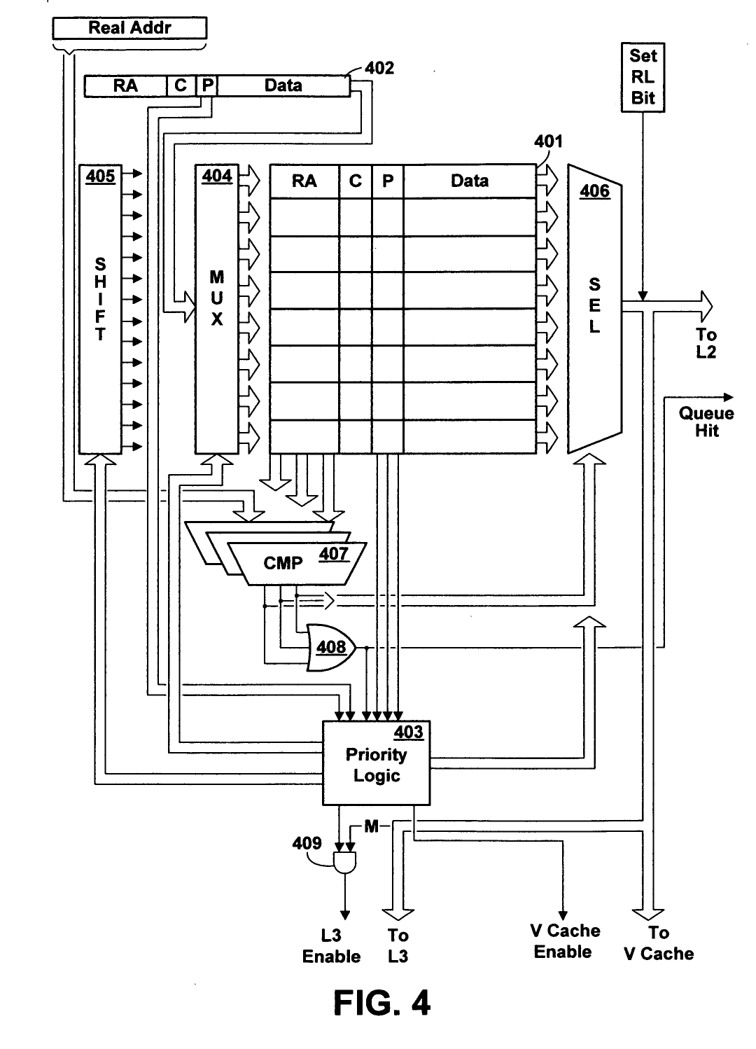

In accordance with the preferred embodiment of the present invention, victim cache 205 operates as a selective victim cache, in which fewer than all of the cache lines evicted from L2 cache 203 are placed in the victim cache. Victim cache queue 204 is the mechanism by which cache lines are selected for inclusion in the victim cache. FIG. 4 illustrates in greater detail the victim cache queue and associated control logic, according to the preferred embodiment.

Victim cache queue 204 comprises a set of ordered queue slots 401, each slot containing the complete contents of a cache line and data associated with the cache line which were evicted from L2 cache 203. I.e, each slot contains a portion of a real address 311 from the cache line index entry 306, the control bits 312 from the cache line index entry, the priority bits 313 from the cache line index entry, and the 128 bytes of data from the cache line 303. In the preferred embodiment, queue 204 contains eight queue slots 401, it being understood that this number may vary.

A priority for entering the victim cache is associated with each cache line. This priority is derived from the pair of priority bits 313. The reload bit represents a high priority (designated priority 3), and a cache line has this priority if the reload bit is set (in this case, the state of the re-reference bit is irrelevant). The re-reference bit represents a middle priority (designated priority 2), and a cache line has a priority of 2 if the re-reference bit is set, but the reload bit is not set. If neither bit is set, the cache line has a low priority (designated priority 1).

When a valid cache line is evicted from L2 cache 203 (the evicted line being indicated as feature 402 in FIG. 4), the priority bits from the evicted line are compared with the priority bits from the queue slots 401 by priority logic 403 to determine an appropriate action. In the preferred embodiment, priority logic 403 operates the queue according to the following rules:
(A) If the priority of the evicted line 402 is higher than at least one of the priorities of the lines in the cache slots 401, then a line from the set of lines in the queue slots having the lowest priority is selected for deletion from the queue, the line selected being that line of the set which has been in the queue longest (i.e., occupies the last line of the lines occupied by the set). In this case, a deleted line output from priority logic 403 to AND gate 409 is activated; this output is logically ANDed with the modified bit of the deleted cache line to generate an L3_Enable signal, causing the deleted cache line to be written to L3 206. If the modified bit of the deleted line is not set, the line is still deleted from queue 204, but it is unnecessary to write it back to the L3 cache. The evicted line 402 is then placed in the queue at the queue slot immediately before the first slot occupied by a line of the same or higher priority using multiplexer 404, and any lines of lower priority are shifted backward in the queue by shift logic 405 as required.
(B) If the priority of the evicted line 402 is not higher than at least one of the priorities of the lines in the cache slots 401, then the evicted line is placed in the first queue slot using multiplexer 404, shift logic 405 causes all other lines in the queue to advance one slot forward, and the line in the last queue slot is selected by selection logic 406 for placement in the victim cache. (This means that a line is selected for eviction from the victim cache according to the appropriate algorithm, preferably LRU, used by the victim cache.) In this case, the output V_Enable from priority logic 403 is activated, causing the output of selector 406 to be written to the victim cache.

Because victim cache queue 204 holds cache lines which have been evicted from the L2 cache but have not yet been entered in the victim cache, the cache lines in the queue will not be contained in either L2 cache or victim cache (although they will be found in the slower L3 cache). Preferably, victim cache queue further includes logic for searching the queue to determine whether a data reference generated by the processor is contained in the queue, and to respond accordingly. As shown in FIG. 4, the queue contains a set of eight comparators 407 (of which three are shown), one respective comparator corresponding to each of the eight queue slots 401. Each comparator concurrently compares the real address portion from the corresponding queue slot with a corresponding portion of the real address of the data reference. If any pair of address portions compares, the output signal of the corresponding comparator 407 is activated, causing selector logic 406 to select the corresponding slot for output, and activating Queue Hit line output from OR gate 408. The activation of the Queue Hit line causes the output of selector 406 to be loaded in L2 cache (and appropriate caches at a higher level) for satisfying the data reference. In this case, another line is evicted from the L2 cache to make room for the line in the queue. If the evicted line is valid, an appropriate queue slot 401 is determined for the evicted line using the priorities described above, shifting data in the queue slots as required. In this case, the cache line in the queue which matched the data reference and was loaded into L2 cache is automatically selected for deletion from the queue, and nothing is advanced from the queue into the victim cache. In rare cases, the cache line which was hit in the queue replaces an invalid cache line in the L2. In these cases, the replaced line does not get put on the queue, leaving a “hole” in the queue. This “hole” is simply treated as an ultra-low priority entry, which is replaced by the next cache line evicted from the L2.

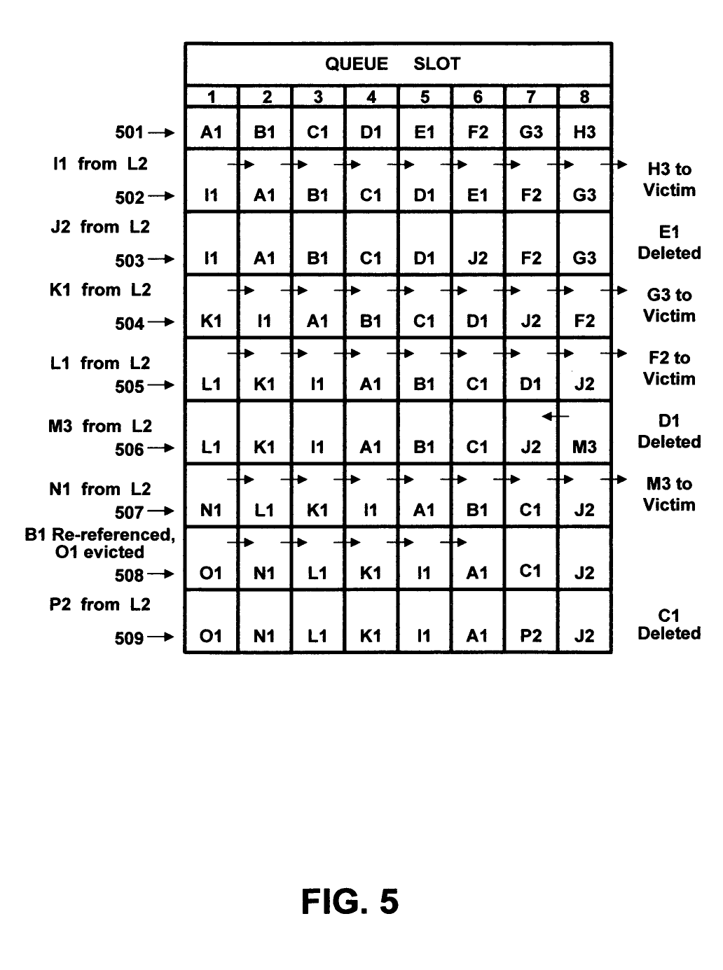

FIG. 5 is an illustrative example of the operation of these rules on victim queue 204, according to the preferred embodiment. As illustrated in FIG. 4, the initial state of the queue is shown in row 501. The queue initially contains eight cache lines designated A through H in queue slots 1 through 8, respectively, in which lines A through E have a priority of 1 (low), line F has a priority of 2 (middle) and lines G and H have a priority of 3 (high). The priority of each queue line follows its letter designation.

From the initial state, we assume that cache line I, having priority I (designated “I1”) is evicted from L2 cache 203. Since none of the lines in the queue have a lower priority than line I, Rule (B) above is applicable. Therefore all the cache lines in the queue are shifted to the right (forward), cache line H3 is placed in the victim cache, and cache line I1 is placed in cache slot 1. Row 502 shows the resultant state of the queue.

At this point, cache line J having priority 2 (J2) is evicted from the L2 cache. Since at least one cache line in the queue has a lower priority than J2 (i.e., lines I1, A1, B1, C1, D1 and E1 all have lower priority than J2), Rule (A) above is applicable. Priority logic 403 selects the line from the set of lines of priority 1 which has been in the queue the longest for deletion from the queue, i.e., cache line E1. J2 is placed in the queue immediately before the most recent queue entry having the same priority, i.e., immediately before cache line F2. The deleted cache line E1 is sent to the L3 queue for possible writing to the L3; since the L3 already contains a copy of the cache line, it is generally not necessary to write it to L3 unless it has changed. Row 503 shows the resultant state of the queue.

Cache lines K and L, each having a priority of 1, are then evicted from the L2 in succession. In both cases, Rule (B) above is applicable, and all cache lines are shifted to the right. When cache line K1 is evicted from L2, cache line G3 is placed in the victim cache; when cache line L1 is evicted from L2, cache line F2 is placed in the victim. Rows 504 and 505 show the state of resultant states of the queue after placing cache lines K1 and L1, respectively.

Cache line M having priority 3 is then evicted from L2. Since at least one cache line in the queue has a priority lower than M3, Rule (A) is applicable. Priority logic selects line D1 for deletion from the queue. Note that the line selected is from the set of lines of the lowest priority (i.e. priority 1), not the set of lines having priority lower than M3. Selection of D1 causes cache line J2 to be shifted backwards in the queue, and cache line M3 to be placed ahead of line J2 so that priority in the queue is always maintained. Row 506 shows the resultant state of the queue after placing line M3.

Cache line N having priority 1 is then evicted from the L2 (Rule (B) applicable), causing all cache lines to be shifted right in the queue, and cache line M3 to be placed in the victim. Row 507 shows the resultant state of the queue after placing line N1.

At this point, the processor generates a memory reference to an address in cache line B1. Because line B1 has been evicted from the L2, and has not yet been placed in the victim cache, both the L2 and the victim signal a cache miss. Comparators 407 detect the presence of cache line B1 in the queue, and signal this to higher level system logic. Line B1 is transmitted from the queue for placement in L2, and cache line O (having priority of 1) is evicted from the L2 to make room for line B1. Note that upon transferring line B1 to the L2, its priority is changed to a 3 (by setting the reload bit). Cache line O1 is placed immediately before the most recent line of the same priority, i.e., immediately before line N1. In order to make this placement, lines N1, L1, K1, K1 and A1 are shifted right to occupy the queue slot vacated by line B1. Row 508 shows the resultant state of the queue.

At this point, cache line P having priority 2 is evicted from the L2. Rule (A) is applicable. Cache line C1 is selected for deletion from the cache, and line P2 is placed in the cache immediately before line J2 (having the same priority). Row 509 shows the resultant state of the queue.

It will be observed that, in the preferred embodiment, high priority cache lines evicted from the L2 203 are always placed in the victim cache 205, while lower priority lines may or may not make it into the victim cache. In particular, the odds that a lower priority line will make it into the victim cache depend on the proportion of lines at a higher priority. As the proportion of lines evicted from the L2 having a higher priority gets larger, then a smaller proportion of the lower priority lines is placed in the victim cache. A large proportion of high priority lines being evicted from the L2 is an indication that the L2 is being overtaxed. Consequently, it is desirable to be more selective in the placement of lines in the victim (which may have insufficient space to handle all the lines that should be kept). In this environment, it is reasonable to heavily favor the placement of high priority lines in the victim. On the other hand, where a large proportion of the lines being evicted is at a low priority, then it is probable that the L2 is sufficiently large to hold the working set of cache lines, and the victim need not be so selective.

In the preferred embodiment described above, the associativity set of each cache is determined using the N address bits immediately above the lowest seven bits (corresponding to the 128-byte cache line size). This form of accessing the cache index and cache data table has the merit of relative simplicity. However, it will be observed that bits 7-17 are sufficient to determine an associativity set in the L2 cache, and a subset of these bits, i.e., bits 7-13, are sufficient to determine an associativity set in the victim cache. Therefore the full contents of each associativity set in the L2 cache map to a single respective associativity set in the victim cache. If a hot associativity set exists in the L2 cache, all lines evicted from it will map to the same associativity set in the victim cache, likely making that set hot also. Therefore, as an alternative embodiment, the victim cache can be indexed using a more complex hashing function in which any single associativity set in the L2 cache maps to multiple associativity sets in the victim cache, and multiple associativity sets in the L2 cache map at least part of their contents to a single associativity set in the victim cache. An example of such a mapping is described in commonly assigned U.S. patent application Ser. No. 10/731,065, filed Dec. 9, 2003, entitled “Multi-Level Cache Having Overlapping Congruence Groups of Associativity Sets in Different Cache Levels”, which is herein incorporated by reference.

In the preferred embodiment described above, priority in the victim cache queue is determined solely with reference to the two priority bits of the evicted line indicating reloading and re-referencing. However, priority could alternatively be based on other factors. In one alternative embodiment, priority could be simplified to two levels recorded in a single bit which is either a reload bit, a re-referenced bit, or a combined bit indicated either reloading or re-referencing. In a second alternative embodiment, priority of an evicted line could be based at least in part on the average priorities of other cache lines in the same associativity set in the L2 cache. I.e., if most or all of the lines in a particular associativity set in the L2 cache have a high priority, then the associativity set is probably a “hot” set. All other things being equal, cache lines evicted from hot sets should be given preference over cache lines evicted from sets which are not hot. One or more extra bits could be added to each entry in the victim cache queue to record the average priority of the lines in the associativity set from which the entry was evicted. These bits could define additional priority levels or an alternative basis for having a higher priority. In a third alternative embodiment, the priorities of cache lines already in the victim cache in the associativity set to which a particular cache line maps could be taken into account in determining whether it should be selected for entry in the victim cache. I.e., where all the lines in the same associativity set of the victim cache have a low priority, then a low priority line should always be selected, but as the proportion of lines with low priority diminishes, then it may be desirable to select fewer low priority lines. Although several specific examples of alternative priority techniques are described herein, it will be understood that other priorities could be used, and that the priority techniques described herein are intended only by way of illustration and not limitation.

In the preferred embodiment, a victim cache queue is used as the principal mechanism for selecting cache lines to be stored in the victim cache. As explained previously, one advantage of the queue is that it can flexibly adjust the rate of storing lower priority cache lines depending on the proportion of lines having lower vs. higher priority. However, it will be appreciated that a selection mechanism for the victim cache need not be a queue, and could take any of various other forms. For example, it would alternatively be possible to make the selective determination immediately upon eviction of a cache line from the higher level cache, based on the priority of the evicted cache line and/or other factors.

Although a specific embodiment of the invention has been disclosed along with certain alternatives, it will be recognized by those skilled in the art that additional variations in form and detail may be made within the scope of the following claims:

What is claimed is:

1. A digital data processing device, comprising:
at least one processor;
a memory;
a first cache for temporarily storing portions of said memory for use by said at least one processor;
a second cache for temporarily storing portions of said memory for use by said at least one processor, said second cache being at a lower level than said first cache, wherein data is stored in said second cache only after being evicted from said first cache; and
a selection mechanism for selecting data evicted from said first cache for storing in said second cache, said selection mechanism selecting less than all valid data evicted from said first cache for storage in said second cache.

2. The digital data processing device of claim 1, further comprising a third cache, said third cache being at a higher level than said first cache and said second cache.

3. The digital data processing device of claim 1, further comprising a third cache, said third cache being at a lower level than said first cache and said second cache.

4. The digital data processing device of claim 1, wherein said selection mechanism comprises a queue for temporarily holding valid data evicted from said second cache, said queue utilizing at least one selection criterion for selectively advancing data in said queue into said second cache or removing data from said queue without advancing data into said second cache.

5. The digital data processing device of claim 4, wherein said queue comprises a queue hit mechanism for determining whether a data reference generated by said processor is contained in said queue, and outputting said data if the data reference is contained in the queue.

6. The digital data processing device of claim 1, wherein said selection mechanism utilizes at least one selection criterion from the set of criteria consisting of: (a) whether data evicted from said first cache has been referenced multiple times in said first cache; (b) whether data evicted from said first cache has been previously evicted from said first cache and re-loaded to said first cache after being evicted; (c) whether other data in an associativity set of said first cache from which said data was evicted has been referenced multiple times in said first cache; and (d) whether other data in an associativity set of said first cache from which said data was evicted has been previously evicted from said first cache and reloaded to said first cache after being evicted.

7. The digital data processing device of claim 1,
wherein said first cache comprises a plurality of associativity sets, each associativity set containing a plurality of cache lines, each associativity set being accessed using a first function of a data address generated by said processor; and
wherein said second cache comprises a plurality of associativity sets, each associativity set containing a plurality of cache lines, each associativity set being accessed using a second function of said data address.

8. The digital data processing device of claim 7,
wherein said data addresses of said plurality of cache lines of each said associativity set of said first cache map to a respective plurality of different said associativity sets of said second cache by said second function; and
wherein said data addresses of said plurality of cache lines of each said associativity set of said second cache map to a respective plurality of different said associativity sets of said first cache by said first function.

9. The digital data processing device of claim 1,
wherein said digital data processing device comprises a plurality of said processors, said plurality of processors sharing said first cache and said second cache.

10. An integrated circuit chip for digital data processing, comprising:
at least one processor core;
a first cache for temporarily storing portions of an external memory for use by said at least one processor core;
a second cache for temporarily storing portions of said memory for use by said at least one processor core, said second cache being at a lower level than said first cache, wherein data is stored in said second cache only after being evicted from said first cache; and
a selection mechanism for selecting data evicted from said first cache for storing in said second cache, said selection mechanism selecting less than all valid data evicted from said first cache for storage in said second cache.

11. The integrated circuit chip of claim 10, further comprising a third cache, said third cache being at a higher level than said first cache and said second cache.

12. The integrated circuit chip of claim 10, wherein said selection mechanism comprises a queue for temporarily holding valid data evicted from said second cache, said queue utilizing at least one selection criterion for selectively advancing data in said queue into said second cache or removing data from said queue without advancing data into said second cache.

13. The integrated circuit chip of claim 12, wherein said queue comprises a queue hit mechanism for determining whether a data reference generated by said processor is contained in said queue, and outputting said data if the data reference is contained in the queue.

14. The integrated circuit chip of claim 10, wherein said selection mechanism utilizes at least one selection criterion from the set of criteria consisting of: (a) whether data evicted from said first cache has been referenced multiple times in said first cache; (b) whether data evicted from said first cache has been previously evicted from said first cache and re-loaded to said first cache after being evicted; (c) whether other data in an associativity set of said first cache from which said data was evicted has been referenced multiple times in said first cache; and (d) whether other data in an associativity set of said first cache from which said data was evicted has been previously evicted from said first cache and reloaded to said first cache after being evicted.

15. The integrated circuit chip of claim 10,
wherein said first cache comprises a plurality of associativity sets, each associativity set containing a plurality of cache lines, each associativity set being accessed using a first function of a data address generated by said processor; and
wherein said second cache comprises a plurality of associativity sets, each associativity set containing a plurality of cache lines, each associativity set being accessed using a second function of said data address.

16. The integrated circuit chip of claim 15,
wherein said data addresses of said plurality of cache lines of each said associativity set of said first cache map to a respective plurality of different said associativity sets of said second cache by said second function; and
wherein said data addresses of said plurality of cache lines of each said associativity set of said second cache map to a respective plurality of different said associativity sets of said first cache by said first function.

17. A method for managing cached data in a digital data processing device, comprising the steps of:
temporarily storing portions of a memory for use by at least one processor of said digital data processing device in a first cache;
selecting discrete portions of valid data in said first cache for eviction from said first cache;
with respect to each said discrete portion of valid data selected for eviction from said first cache, making a selective determination whether to temporarily store the respective discrete portion in a second cache, said second cache being at a lower level than said first cache, wherein data is stored in said second cache only after being evicted from said first cache;
wherein said selective determination step determines to store at least some of said discrete portions in said second cache, and wherein said selective determination step determines not to store at least some of said discrete portions in said second cache.

18. The method of claim 17, wherein said selective determination step comprises temporarily holding valid data evicted from said second cache on a queue, and selectively advancing data in said queue into said second cache or removing data from said queue without advancing data into said second cache using at least one selection criterion.

19. The method of claim 17, wherein said selective determination step utilizes at least one selection criterion from the set of criteria consisting of: (a) whether data evicted from said first cache has been referenced multiple times in said first cache; (b) whether data evicted from said first cache has been previously evicted from said first cache and re-loaded to said first cache after being evicted; (c) whether other data in an associativity set of said first cache from which said data was evicted has been referenced multiple times in said first cache; and (d) whether other data in an associativity set of said first cache from which said data was evicted has been previously evicted from said first cache and reloaded to said first cache after being evicted.
